(19) United States
(12) Patent Application Publication
(10) Pub. No.: US 2009/0254853 A1
(43) Pub. Date: Oct. 8, 2009

(54) METHOD OF VIEWING A SINGLE DOCUMENT IN MULTIPLE SCALED VIEWS

(76) Inventor: Donald Jacob, Burbank, CA (US)

Correspondence Address: STETINA BRUNDA GARRED & BRUCKER, 75 ENTERPRISE, SUITE 250, ALISO VIEJO, CA, 92656, US

(21) Appl. No.: 12/061,851

(22) Filed: Apr. 3, 2008

(51) Int. Cl. G06F 3/048

(52) U.S. Cl. 715/800; 715/769

(57) ABSTRACT

There is provided a method of viewing a document. The method includes displaying a first document in a first viewing window using a first scale value and a first origin coordinate. The first viewing window defines a coordinate array. The method includes determining a second origin coordinate within the coordinate array. The method includes determining a second scale value greater than the first scale value. The method includes displaying the first document in a second viewing window using the second origin coordinate and the second scale value.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND

1. Technical Field

The present invention relates to the displaying of documents upon a graphic user interface, more particularly, to a method of viewing a single document in multiple scaled views.

2. Description of the Related Art

A topic of interest is graphic user interfaces that allow users to interact with a computer via one or more windows displayed upon a monitor or screen. The ability to concurrently display or have readily available a multiplicity of windows continues to increase in popularity. A window is a visual area of a graphic user interface, and is typically represented as two-dimensional rectangular shapes. Interaction with a window is accomplished via a user input device, such as a mouse or trackball that controls a graphically displayed pointer or cursor upon the display, a keyboard, and/or a touch screen.

A workspace window is one in which documents may be displayed and/or accessed. For example, a drawing document associated with drawing or graphics application may be accessed in a workspace window. Multiple workspace windows may be concurrently displayed upon a given monitor. Operating systems commonly support multiple concurrent instances of workspace windows associated with the same or different applications. A window manager is computer software that controls the placement, appearance and interaction with windows displayed in a graphic user interface. The operating system and each application would have their own window managers.

An active window is one which is the currently focused window or otherwise currently selected to receive input. At any given time, only a single workspace window may be “active.” Different window managers indicate the currently-active window in different ways and allow the user to switch between windows in different ways.

For example, using the mouse to maneuver a mouse cursor over a portion of a window while clicking a mouse button may cause that window to become active. Some window managers may make the window under the mouse cursor active without the need to click the mouse button. Window managers often provide a way to select the active window using the keyboard as an alternative to the mouse. Pressing the appropriate key combination typically cycles through all visible windows in some order, though other actions are possible. An active window may be indicated by having a different colored or highlighted title bar or window frame. Many window managers provide a region of the screen containing some kind of visual control (often a button) for each window displayed on the screen. Each button typically contains the title of the window and may also contain a corresponding icon. This area of the screen generally provides some kind of visual indication of which window is active. For example, the active window's button may appear “pushed in.” It is also usually possible to switch the active window by clicking on an appropriate button.

Typically, workspace windows may be moved or translated about the monitor. Such workspace windows may be overlapping or non-overlapping. Moreover, active windows may not always lie in front of all other windows on the display screen.

Within a given workspace window, there may be multiple “child windows.” An instance of a graphics application may be launched which displays a workspace window. Within such workspace window (a “parent window”) there may be displayed multiple documents each in its own child window. Each of the child windows may represent different documents, different portions of data associated with a common document (such as levels or layers of a drawing document), multiple instances of a same document, or multiple versions of the same document. A parent window would define a window frame and access to a variety of controls, such as tool bars, buttons, icons, menus, and the like. Such controls are applied to the various child windows within the associated parent window.

Child windows may be displayed in windows of various sizing relative to their associated parent window and/or other child windows. For example, child windows may be sized to fit the entirety of their common parent window. In such a case, the child windows would be overlapping. Visual indicators may be provided to represent the overlapped child window. For example, each child window may have a tab extending from its window frame with each child window's tab being off-set from other tabs. Regardless of the order of overlap of the child windows, a visual indication would be displayed to provide user information as to the number, identity and/or order of the overlapped child windows. This may be referred to as a “tabbed view.” This enables the child windows to be sized as large as possible (i.e., the extent of their parent window). Child windows may also be displayed in a partially overlapping manner. For example, each newly launched child window may be initially displayed with an offset (vertical and horizontal). This has the advantage of allowing a portion of each child window to be simultaneously displayed to provide the user with some information as to the contents of each of the child windows while also attempting to size the child windows as large as possible.

Another approach to displaying child windows is to launch non-overlapping windows. The maximum relative sizing of the child windows in this approach becomes significantly reduced in comparison to overlapping child windows. Child windows displayed in this approach may be referred to as a “window pane view,” as this is similar to appearance of glass window panes.

The functionality of launching child windows or split views of a document or documents is particularly beneficial for viewing large format drawings. This is because a user may often need to view a drawing with a large zoom factor and the split feature allows several different parts of a drawing to be readily accessible.

Positional offset and scale are major parameters when displaying a document, such as a drawing document. It should also be noted that page number and rotation may also be significant as well. It is important to make a distinction between a document coordinate system and a screen or window coordinate system. A document coordinate system represents the physical size of the document independent of how the document is displayed in a window. The fundamental unit corresponds to a real measurement, such as inches or centimeters. The physical size of the documents would be defined by length and width dimensions or by coordinates of its four vertex points. The screen coordinate system represents how the document is displayed and its fundamental unit is associated with the screen display, such as pixels.

The positional offset parameter relates to the coordinate system of the displayed document in comparison to that of the actual document. The origin point for an actual document is typically initialized as being the upper left corner having zero X (horizontal) and zero Y (vertical) coordinates (e.g., (0, 0)). The origin of the display may be the upper left corner of the display. The origin point for display of the document may not be the same as that of the actual document. For example, the document may be displayed such that the upper left corner of the document (the origin of the actual document) is not even displayed. The display of the document may be changed by panning the view of the document. For example, the view of the document may be panned horizontally to the right with the origin point of the actual document translating to the left relative to the display. The X coordinate of the off-set would become increasingly negative as the display of the document is further panned to the right.

The scale parameter pertains to the zoom factor of the displayed document. Typically a one hundred percent scale factor (100% or 1:1) results in a document being displayed on the screen that is generally near the actual sizing of the document. An increase in the scale such as 2:1 would result in the displayed document appearing twice the actual size (i.e., zoomed in). The zoom and offset parameters can be used to convert points between the drawing coordinate system and the screen coordinate system.

In view of the ever increasing interest and utilization in the viewing and displaying of a document or multiple documents, there is a need in the art for an improved system for interacting with multiple displayed documents.

### BRIEF SUMMARY

There is provided a method of viewing a document. The method includes displaying a first document in a first viewing window using a first scale value and a first origin coordinate. The first viewing window defines a coordinate array. The method includes determining a second origin coordinate within the coordinate array. The method includes determining a second scale value greater than the first scale value. The method includes displaying the first document in a second viewing window using the second origin coordinate and the second scale value.

According to various embodiments, the first and second viewing windows may be within a single workspace window. Alternatively, the first and second viewing windows may be within separate workspace windows. The second origin coordinate may be determined via the use of a mouse cursor. The second scale value may be determined via the use of a mouse cursor. The second origin coordinate and the scale value may be selected via a click and drag operation of a mouse cursor. The determining of the second scale value may include determining a third origin coordinate within the coordinate array and using the second and third origin coordinates. The determining of the second scale value may include defining a rectangle within the coordinate array. The second origin coordinate may correspond to a vertex of the rectangle. The first viewing window has a first window frame dimension, and the second viewing window has a second window frame dimension. The first and second window frame dimensions may be the same. The method may further include redisplaying a first document in a third viewing window using the first scale value and a first origin coordinate, the third viewing window has a third window frame dimension less than the first window frame dimension. The second viewing window may have a second window frame dimension, the second and third window frame dimensions may be the same. The second and third window frame dimensions may be generally contained within the first window frame dimension.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a perspective view of an exemplary computer system that may be capable to perform functions for use with aspects of the present invention including a display monitor;

FIG. 2 is a block diagram of system components of the exemplary computer system of FIG. 1;

FIG. 3 is a plan view of an exemplary document;

FIG. 4 is a plan view of a workspace window with a first viewing window displaying the exemplary document at a first scale value and a cursor;

FIG. 5 is the view of the workspace window of FIG. 4 with a selection box (in dashed line) indicated across a portion of the exemplary document;

FIG. 6 is the view of the workspace window of FIG. 5 with second and third viewing windows replacing the first viewing window and with the second viewing window displaying the document and the second viewing window displaying the document with a second scale value greater than the first scale value;

FIG. 7 is a symbolic view of the document and the first viewing window of FIG. 4;

FIG. 8 is a symbolic view of the document and the second viewing window of FIG. 6;

FIG. 9 is a symbolic view of the document and the third viewing window of FIG. 6;

FIG. 10 is the view of the workspace window of FIG. 5 with a fourth viewing window replacing the first viewing window and with the fourth viewing window displaying the document in a tabbed view format

FIG. 11 is the view of the workspace window of FIG. 10 with a fifth viewing window being active and overlapping the fourth viewing window displaying a selected portion of the document at an increased scale value;

FIG. 12 is a plan view of the display monitor of FIG. 1 displaying a workspace window and viewing window similar to that of FIG. 5 and another viewing window outside of the workspace window displaying a selected portion of the document at an increased scale value; and

FIG. 13 is a plan view of the display monitor of FIG. 1 displaying a workspace window and viewing window similar to that of FIG. 5 and another similar display monitor displaying another workspace window displaying a selected portion of the document at an increased scale value.

### DETAILED DESCRIPTION

The detailed description set forth below in connection with the appended drawings is intended as a description of the presently preferred embodiment of the invention, and is not intended to represent the only form in which the present invention may be constructed or utilized. The description sets forth the functions and the sequence of steps for developing and operating the invention in connection with the illustrated embodiment. It is to be understood, however, that the same or equivalent functions and sequences may be accomplished by different embodiments that are also intended to be encompassed within the spirit and scope of the invention. It is further understood that the use of relational terms such as first and second, and the like are used solely to distinguish one from another entity without necessarily requiring or implying any actual such relationship or order between such entities.

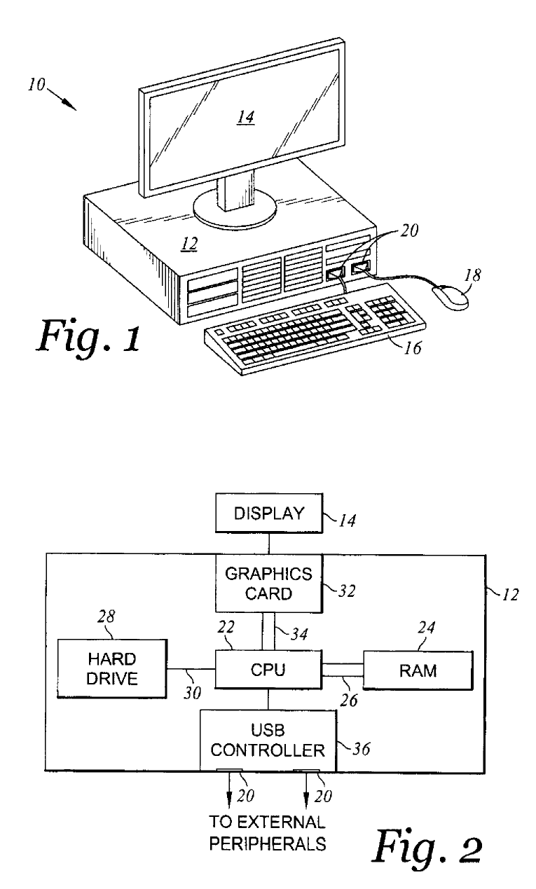

With reference to FIG. 1, an exemplary hardware environment in which aspects of the present invention may be implemented includes a computer system 10 with a system unit 12 and a display unit 14. The display monitor 14 graphically displays output from the data processing operations performed by the system unit 12. The display monitor 14 is a visual output device and includes some form of screen. The display monitor 14 may be of a Liquid Crystal Display (LCD) type, a Cathode Ray Tube (CRT) type, or any other suitable type of display. Devices such as a keyboard 16 and a mouse 18 provide input to the data processing operations, and are connected to the system unit 12 via a USB port 20. Various other input and output devices may be connected to the system unit 12, and alternative interconnection modalities may be substituted with the USB port 20.

As shown in the block diagram of FIG. 2, the system unit 12 includes a Central Processing Unit (CPU) 22, which may represent one or more conventional types of such processors, such as an IBM PowerPC, Intel Pentium (x86) processors, and so forth. A Random Access Memory (RAM) 24 temporarily stores results of the data processing operations performed by the CPU 22, and is interconnected thereto typically via a dedicated memory channel 26. The system unit 10 may also include permanent storage devices such as a hard drive 28, which are also in communication with the CPU 22 over an i/o bus 30. Other types of storage devices such as tape drives, Compact Disc drives, and the like may also be connected. A graphics card 32 is also connected to the CPU 22 via a video bus 34, and transmits signals representative of display data to the display monitor 14. As indicated above, the keyboard 16 and the mouse 18 are connected to the system unit 12 over the USB port 20. A USB controller 36 translates data and instructions to and from the CPU 22 for external peripherals connected to the USB port 20. Additional devices such as printers, microphones, speakers, and the like may be connected to the system unit 12.

The system unit 12 may utilize any operating system having a graphical user interface (GUI), such as WINDOWS from Microsoft Corporation of Redmond, Wash., MAC OS from Apple, Inc. of Cupertino, Calif., various versions of UNIX with the X-Windows windowing system, and so forth. The system unit 12 executes one or more computer programs, with the results thereof being displayed on the display monitor 14. Generally, the operating system and the computer programs are tangibly embodied in a computer-readable medium, e.g. one or more of the fixed and/or removable data storage devices including the hard drive 28. Both the operating system and the computer programs may be loaded from the aforementioned data storage devices into the RAM 24 for execution by the CPU 22. The computer programs may comprise instructions which, when read and executed by the CPU 22, cause the same to perform the steps to execute the steps or features of the present invention.

The foregoing computer system 10 represents only one exemplary apparatus suitable for implementing aspects of the present invention. As such, the computer system 10 may have many different configurations and architectures. Any such configuration or architecture may be readily substituted without departing from the scope of the present invention.

Referring now to FIG. 3, there is depicted an exemplary document 38. The exemplary document 38 may be graphically represented via the computer system 10. The document 38 is symbolic in nature and represents any document or computer file that may be displayed at a graphic user interface such as the display monitor 14. The document 38 may be based upon graphic, drawing, data, or word processing files for example, and may be stored in any number of formats in computer memory, such as in the hard drive 28 and/or RAM 24. The document 38 of the embodiment illustrated is of a general rectangular configuration and is defined by four vertices 40a-d. The document 38 is bounded by top, right, bottom, and left sides 42a-d. The document 38 may include various data objects, such as the data object 44, represented as an oval shape. Such data objects may be any graphical object, text or symbols. The document 38 also includes a background 46. Moreover, the document 38 may include layers or levels of data objects. It is contemplated that the document 38 may be manipulated, viewed and/or edited via a computer application implemented by the computer system 10 in accordance with those techniques and methods which are well known to one of ordinary skill in the art.

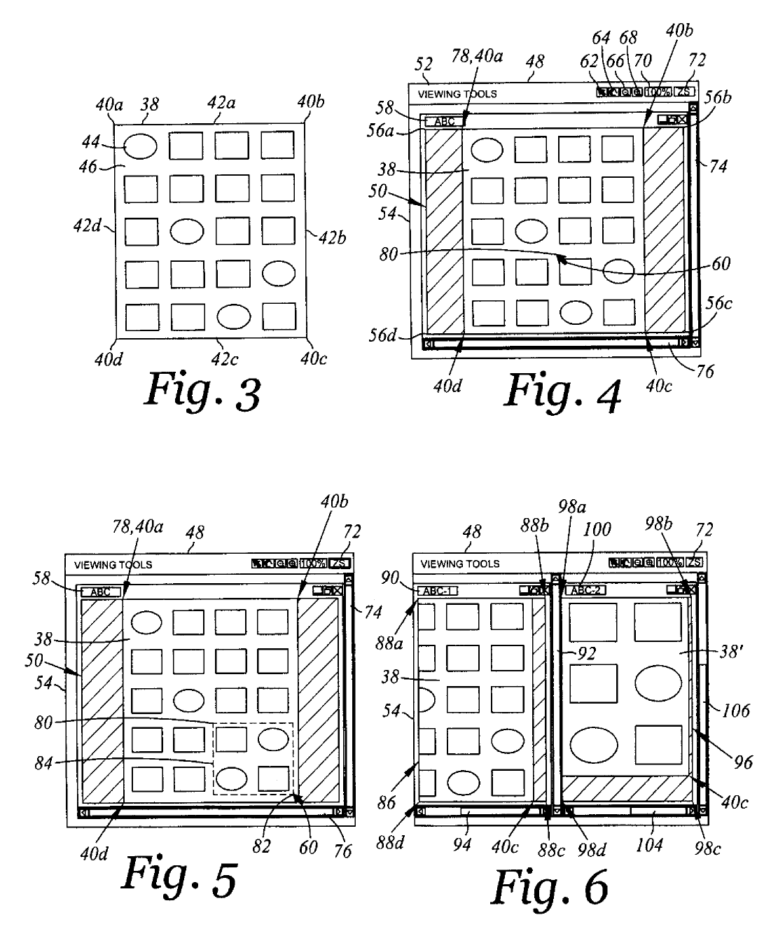

Referring additionally to FIG. 4 there is depicted a workspace window 48 that may be displayed upon the display monitor 14. The workspace window 48 may be launched and controlled by an application residing in computer memory of the computer system 10. The document 38 may be displayed within the workspace window 48. More specifically the workspace window 48 includes a first viewing window 50 in which the document 38 is displayed. The workspace window 48 includes a workspace window frame 52 that has a periphery 54 that surrounds the first viewing window 50. The first viewing window 50 includes first viewing window vertices 56a-d that generally define the display dimensions of the first viewing window 50. A tab 58 may be used to identify the document and/or the instance of the document being displayed within the first viewing window 50 and may include identifying indicia (sample indicia of “ABC” is indicated).

With regard to the specific interaction between a user and the computer system 10, a cursor 60 is directed via the mouse 18 to locations within the display monitor 14. The mouse 18 may include one or more mouse buttons. The application defines a number interactive elements which may be visually connected to the workspace window 48 or accessed via menus or pop-up menus for example. A data processing procedure may be initiated by the user activating such interactive elements through clicking the mouse buttons while the cursor 60 is positioned on or near the interactive element. Additionally, a key or keys on the keyboard 16 may be pressed to initiate a data processing procedure. It will also be understood by a person having ordinary skill in the art that while the following description of the invention refers to steps carried out in an exemplary computer system 10, any other data processing device having similar functionality may be used without departing from the scope of the invention. Moreover, while the following description of the invention refers to “clicking” a mouse button, “positioning” a cursor 60 within the monitor 14, “selecting” using the cursor 60 and so forth, a person having ordinary skill in the art will recognize these terms to refer to any similar user interaction with the computer system 10 through a graphical user interface.

In the embodiment illustrated, the workspace window 48 includes interactive elements in a toolbar that has various example viewing tools. As will be discussed in further detail, the viewing tools include a cursor icon 62, a translation icon 64, a demagnify icon 66, a magnify icon 68, a scale icon 70, and a zoom split icon 72. In addition, the first viewing window 50 may include vertical and horizontal scrollbars 74, 76 that may be configured to visually represent the relative position and amount of the document 38 presently being displayed in the first viewing window 50.

According to an aspect of the present invention there is provided a method of viewing a document, such as the exemplary document 38. The method includes displaying the document 38 in a first viewing window, such as the first viewing window 50, using a first scale value and a first origin coordinate 78. The first viewing window 50 defines a coordinate array. With reference to FIGS. 4 and 5, the method further includes determining a second origin coordinate 80 within the coordinate array. As used herein the term “coordinate array” refers to an organization or matrix of ordered coordinates from which the first and second origin coordinates 78, 80 may be selected. The method further includes determining a second scale value greater than the first scale value. As illustrated in FIG. 6, the method further includes displaying the first document 38 in another viewing window 96 using the second origin coordinate 80 and the second scale value.

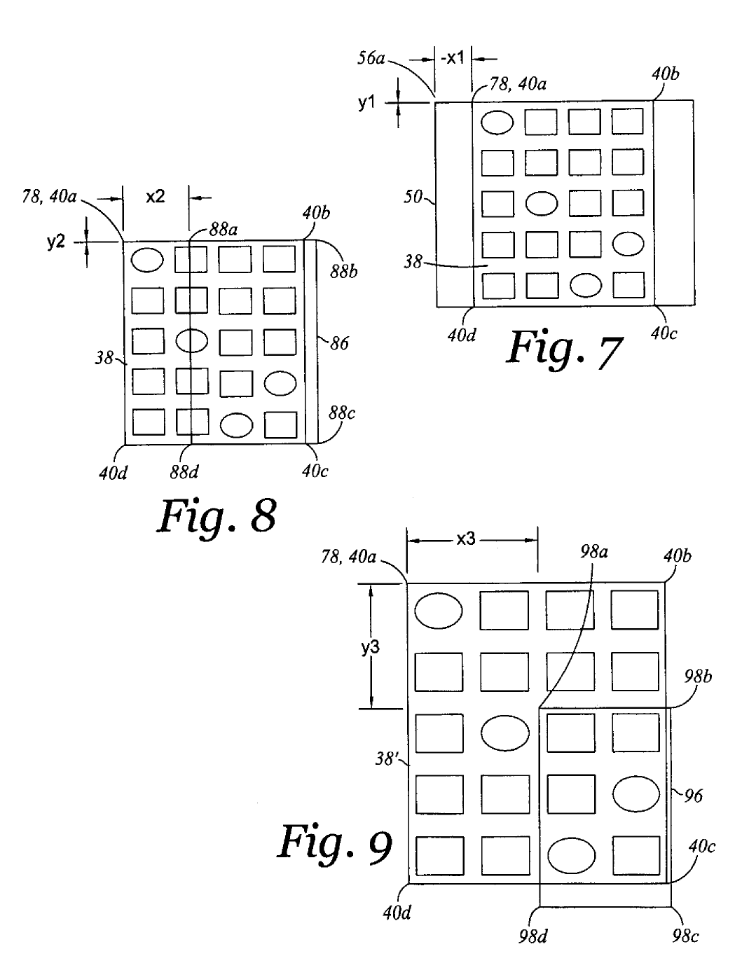

In further detail, as mentioned above, the method includes displaying the document 38 in the first viewing window 50 using a first origin coordinate 78. Referring now to FIG. 7 there is depicted a symbolic view of the document 38 and the first viewing window 50 of FIG. 4. In this particular embodiment, the first origin coordinate 78 coincides with the vertex 40a (i.e., this is the upper left corner of the document 38). The document 38 may be displayed in the first viewing window 50 through the use of the first origin coordinate 78 in relation to the vertex 56a. In this example, the first origin coordinate 78 is offset from the vertex 56a by a horizontal value of “−x1” and a vertical value of “y1” that is equal to zero offset.

As further mentioned above, the method includes displaying the document 38 in the first viewing window 50 using the first scale value. In this regard, the application may initially determine a correlation between the actual sizing of the document 38 and its scaled size. For example, a standard letter size of 8.5 inches by 11 inches may correlate to a generally similar size when viewed on a display screen, such as the display monitor 14. The scale icon 70 may be used to indicate the displayed scale value of the active window. In FIGS. 4-5, the active window is the first viewing window 50 and the first scale value is indicated by the scale icon 70 as being 100%. As such, in this example, 100% of the document 38 is viewable in the first viewing window 50. It is understood that the scale values are relative terms related to the display of documents in relation to an initial reference scale value between the document coordinate system and the viewing window coordinate system.

As mentioned above, the method further includes determining a second origin coordinate 80 within the coordinate array and a second scale value. With reference to FIG. 4, the user may initially select the zoom split icon 72. In this example application, the zoom split icon 72 may enable a tool that allows the user to input to the application the second origin coordinate 80 and the second scale value through the cursor 60 and the controlling mouse 18. In this regard, the zoom split icon 72 is first selected by positioning the cursor 60 over the zoom split icon 72 and clicking the mouse button (not shown) of the mouse 18. Next, the user navigates the cursor 60 to a position over the document 38 where the user desires to input the location of the first origin coordinate 80 by clicking the mouse button at such location. Referring now to FIG. 5, at this point, the user may continue holding down the mouse button after the clicking of the mouse button and position (also referred to as a “click and drag” operation) the cursor 60 to a desired location of a third origin coordinate 82. The user may select the third origin coordinate 82 by “unclicking” the mouse button at such desired location of the third origin coordinate 82.

The application may be configured to receive the second and third origin coordinates 80, 82 and to determinate the second scale value using the second and third origin coordinates 80, 82. The application may use the second and third origin coordinates to define opposing vertices of a rectangle and display such rectangle as a zoom box 84 (as indicated in dashed lining). Upon the unclicking of the mouse button (and thereby inputting the third origin coordinate 82), the application may be configured to launch two new viewing windows, namely, a second viewing window 86 and the previously mentioned viewing window 96 (which may also be referred to as a third viewing window 96). In this embodiment, the second and third viewing windows 86, 96 replace the first viewing window 50 in the workspace window 48. This embodiment may be referred to as a split view, as the first viewing window 50 is “split” by being replaced by the second and third viewing windows 86, 98 in a side by side manner. The second and third viewing windows 86, 96 each has frame dimensions that are generally the same as each other and each has a footprint of approximately half of the first viewing window 50 within the workspace window 48. Thus, the first and second viewing windows 86, 96 each have window frame dimensions that fit within the first window frame dimension of the first window frame 50. This may be referred to as a “split view.”

The second viewing window 86 is defined by vertices 88a-d. A tab 90 may be used to identify the displayed contents of the second viewing window 86. In this example, the tab 90 indicates “ABC-1” which may be used to signify to the user that the document 38 is being displayed, however, in another view than previously displayed in the first viewing window 50.

The second viewing window 86 may include vertical and horizontal scroll bars 92, 94. The vertical and horizontal scroll bars 92, 94 may be used to indicate the displayed portions of the document 38 in comparison to the non-displayed portions. In this regard, the vertical scroll bar 92 is filled with a solid bar so as to indicate that the vertical dimension of the document 38 “fits” and is completely displayed within the vertical dimension of the second viewing window 86. The horizontal scroll bar 94 is partially filled with a solid bar so as to indicate that the horizontal dimension of the document 38 does not completely fit within the horizontal dimension of the second viewing window 86 as it is only partially displayed. Thus, the left portion of the document 38 is not displayed in the second viewing window 86. The application may be configured to display the document 38 in the second viewing window 86 in a manner that generally centers that portion of the document 38 that corresponds to the location of the previously selected zoom box 84. Moreover, the application may further be configured to display the document 38 with a same scale value, the first scale value, of the document 38 as previously used to the display the document 38 in the first viewing window 50. It is understood, that other displayed offsets positions of the document 38 in the second viewing window 50 and other scale values may be utilized in other embodiments.

Referring now to FIG. 8 there is depicted a symbolic view of the document 38 and the second viewing window 86 of FIG. 6. In this particular embodiment in relation to the coordinate system of the second viewing window 86, a first origin coordinate 78 coincides with the vertex 40a (i.e., this is the upper left corner of the document 38). The document 38 may be displayed in the second viewing window 86 through the use of the first origin coordinate 78 in relation to the vertex 88a. In this example, the first origin coordinate 78 is offset from the vertex 88a by a horizontal value of “x2” and a vertical value of “y2” that is equal to zero offset.

The third viewing window 96 is defined by vertices 98a-d. A tab 100 may be used to identify the displayed contents of the third viewing window 96. In this example, the tab 100 indicates “ABC-2” which may be used to signify to the user that a document 38′ is being displayed which is the document 38, however, with a different scale value and in another view than previously displayed in the first or second viewing windows 50, 86.

The third viewing window 96 may include vertical and horizontal scroll bars 102, 104. The vertical and horizontal scroll bars 106, 104 may be used to indicate the displayed portions of the document 38′ in comparison to the non-displayed portions. The vertical and horizontal scroll bars 106, 104 are both partially filled with a solid bar so as to indicate that the vertical and horizontal dimensions of the document 38′ do not completely fit within the vertical and horizontal dimensions of the third viewing window 96 as it is only partially displayed. Thus, the top and left portions of the document 38′ are not displayed in the third viewing window 96. The application may be configured to display the document 38′ in the third viewing window 86 in a manner that generally centers that portion of the document 38 that corresponds to the location of the previously selected zoom box 84.

Referring now to FIG. 9 there is depicted a symbolic view of the document 38′ and the third viewing window 96 of FIG. 6. In this particular embodiment in relation to the coordinate system of the third viewing window 96, a first origin coordinate 78 coincides with the vertex 40a (i.e., this is the upper left corner of the document 38′). The document 38′ may be displayed in the third viewing window 96 through the use of the first origin coordinate 78 in relation to the vertex 98a. In this example, the first origin coordinate 78 is offset from the vertex 98a by a horizontal value of “x3” and a vertical value of “y3.”

As previously mentioned the method includes determining a second scale value greater than the first scale value. In this regard, the third viewing window 96 may display the document 38′ at the second scale value that substantially maximizes the viewing of that portion of the portion of the document 38 that corresponds to the location of the previously selected zoom box 84 (this functionality is sometimes referred to as a “fit in window” function). This “maximizing” within the bounds of the third viewing window 96 results in the displaying of the document 38′ as being “zoomed in” in comparison to the display of the document 38 in the first viewing window 50. As such, the zoom split icon 72 is used to initiate a “zoomed in” display of the document 38 in a new window that is “split” from the original window (the first viewing window 50). Thus, in this embodiment, the determining of the second scale value includes defining a rectangle within the coordinate array (i.e., defining of the zoom box 84). It is understood, that other displayed scale values of the second scale value of the document 38 in the second viewing window 86 may be utilized in other embodiments, so long as the second scale value is greater than the first scale value.

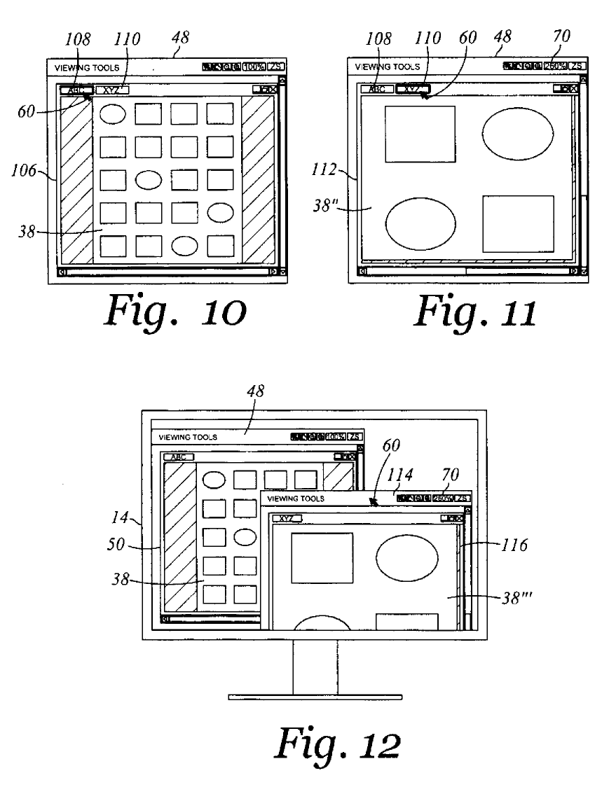

Referring now to FIGS. 10 and 11, there is depicted another embodiment. Similar reference numerals as those in relation to the embodiments shown in FIGS. 1-9 are used to indicate similarly configured components, however, with those differences as noted below. According to this embodiment, rather than “splitting” the first viewing window 50 into smaller side by side windows (e.g., the second and third viewing window 86, 96) in a split view, a “tabbed view” may be initiated.

FIG. 10 is the view of the workspace window 48 of FIG. 5 with a fourth viewing window 106 replacing the first viewing window 50. Subsequent to the selection of the zoom box 84 as illustrated in FIG. 5 and discussed above, the fourth viewing window 106 is initiated and displays the document 38 in a tabbed view format. A tab 108 is used to identify the contents displayed in the fourth viewing window 106. The tab 108 indicates “ABC” which may correspond to the same contents displayed with a same scale value as in the first viewing window 50. A tab 110 is also provided. It is noted that tab 108 is highlighted in comparison to the tab 110. This is because the fourth viewing window 106 is associated with the tab 106 and is active (and presently brought to the foreground). The cursor 60 may be used by the user to toggle back and forth between viewing of either the fourth or fifth viewing windows 106, 112.

FIG. 11 is the view of the workspace window 48 of FIG. 10 with a fifth viewing window 112 being active and “overlapping” the fourth viewing window 106. The tab 110 is highlighted in comparison to the tab 108. This is because the fifth viewing window 112 is associated with the tab 108 and is active (and presently brought to the foreground). In this example, the tab 110 indicates “XYZ” which may be used to signify to the user that a document 38″ is being displayed which is the document 38, however, with a different scale value and in another view than previously displayed in the first or fourth viewing windows 50, 106. It is noted that the viewing tools of the workspace window 48 correspond to control of the active window. As such, in FIG. 11, the scale icon 70 indicates “260% which corresponds to the scale value of the document 38” of the fifth viewing window 112 which is the active window. In this embodiment, the forth and fifth viewing windows 106, 112 each have window frame dimensions generally equal to that of the originating window, the first viewing window 50. This tabbed view format allows for the initiation of the fourth and fifth viewing windows 106, 112 to be relatively large in comparison is windows initiated in a split view (which as approximately half the size). However, the split view format allows for a simultaneous viewing the windows.

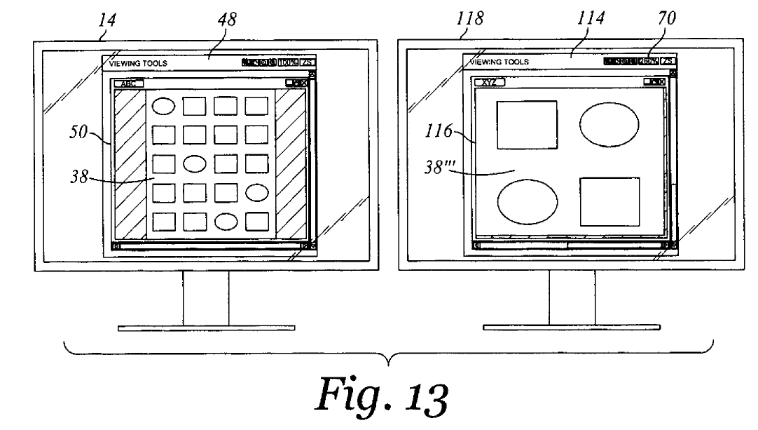

Referring now to FIGS. 12 and 13, there is depicted another embodiment. Similar reference numerals as those in relation to the embodiments shown in FIGS. 1-9 are used to indicate similarly configured components, however, with those differences as noted below. According to this embodiment, rather than “splitting” the first viewing window 50 in to smaller side by side windows (e.g., the second and third viewing window 86, 96) in a split view, another workspace window 114 may be initiated.

FIG. 12 is a plan view of the display monitor 14 of FIG. 1 displaying the workspace window 48 including the first viewing window 50. Subsequent to the selection of the zoom box 84 as illustrated in FIG. 5 and discussed above, a second workspace window 114 is initiated and displays a sixth viewing window 116. The sixth viewing window 116 displays a document 38′″ which is the document 38, however, with a different scale value. The second workspace window 114 may be launched so as to be partially overlapping with the workspace window 48. The second workspace window 114 may include its own tools which may function independently of those tools included in the workspace window 48. As such, in this embodiment the sixth viewing window 116 is launched outside of the of the originating workspace window 48. The sixth viewing window 116 displays a document 38′″ which is the document 38, however, with a different scale value. In FIG. 12, the scale icon 70 indicates “260% which corresponds to the scale value of the document 38′” of the sixth viewing window 116. In this embodiment, the sixth viewing window 116 has window frame dimensions generally equal to that of the originating window, the first viewing window 50.

FIG. 13 is a plan view of the display monitor 14 displaying the workspace window 48. A second display monitor 118 is provided. The second workspace window 114 may be translated about the display monitor 14. Where the user has included a second display monitor 118 into the computer system 10, the second workspace window 114 may be translated to be displayed upon the second display monitor 118. This may be accomplished via “drag” operation using the cursor 60 clicked on the second workspace window 114. This allows the first and sixth viewing windows 50, 116 to respectively display the documents 38, 38′″ is a relatively large format.

While the steps and the user inputs necessary to generate and modify the data objects and interact with application tools as discussed above have been detailed with reference to mouse inputs in specific sequences, alternative sequences may also be utilized. A person having ordinary skill in the art will recognize the above described sequences are the most commonly utilized in graphical computer applications, but there are other existing sequences that may be substituted without departing from the scope of the present invention.

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show particulars of the present invention in more detail than is necessary for the fundamental understanding of the present invention, the description taken with the drawings making apparent to those skilled in the art how the several forms of the present invention may be embodied in practice.

What is claimed is:

1. A method of viewing a document, the method comprising:
displaying a first document in a first viewing window using a first scale value and a first origin coordinate, the first viewing window defining a coordinate array;
determining a second origin coordinate within the coordinate array;
determining a second scale value greater than the first scale value; and
displaying the first document in a second viewing window using the second origin coordinate and the second scale value.

2. The method of claim 1 wherein the first and second viewing windows are within a single workspace window.

3. The method of claim 1 wherein the first and second viewing windows are within separate workspace windows.

4. The method of claim 1 wherein the second origin coordinate is determined via the use of a mouse cursor.

5. The method of claim 1 wherein the second scale value is determined via the use of a mouse cursor.

6. The method of claim 1 wherein the second origin coordinate and the scale value are selected via a click and drag operation of a mouse cursor.

7. The method of claim 1 wherein the determining of the second scale value includes determining a third origin coordinate within the coordinate array and using the second and third origin coordinates.

8. The method of claim 1 wherein the determining of the second scale value includes defining a rectangle within the coordinate array.

9. The method of claim 8 wherein the second origin coordinate corresponds to a vertex of the rectangle.

10. The method of claim 1 wherein the first viewing window has a first window frame dimension, the second viewing window has a second window frame dimension, the first and second window frame dimensions are the same.

11. The method of claim 1 wherein the first viewing window has a first window frame dimension, the method further includes redisplaying a first document in a third viewing window using the first scale value and a first origin coordinate, the third viewing window has a third window frame dimension less than the first window frame dimension.

12. The method of claim 11 wherein the second viewing window has a second window frame dimension, the second and third window frame dimensions are the same.

13. The method of claim 12 wherein the second and third window frame dimensions are generally contained within the first window frame dimension.
